(19) United States
(12) Patent Application Publication
(10) Pub. No.: US 2006/0039056 A1
(43) Pub. Date: Feb. 23, 2006

(54) Beam scanning optical system

(75) Inventor: Ju-hyun Lee, Seoul (KR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Samsung Electronics Co., Ltd., Gyeonggi-do (KR)

(21) Appl. No.: 11/206,084

(22) Filed: Aug. 18, 2005

(30) Foreign Application Priority Data
Aug. 18, 2004 (KR) 10-2004-0065033

(51) Int. Cl. G02B 26/08

(52) U.S. Cl. 359/212

(57) ABSTRACT

Provided is a beam scanning optical system. The beam scanning optical system includes a scanner scanning an incident light beam, a projection optical system projecting the image of the light beam scanned by the scanner onto an image plane, and a resolution enhancement unit improving resolution so that the light beam image can be formed on an image plane at a higher resolution than determined by the scanner and the projection optical system. Accordingly, the optical system can improve resolution without increasing the size of the scanning surface of the scanner. As a result, resolution can be improved irrespective of the size limit of the scanner.

### BACKGROUND OF THE DISCLOSURE

This application claims the priority of Korean Patent Application No. 10-2004-0065033, filed on Aug. 18, 2004, in the Korean Intellectual Property Office, the disclosure of which is incorporated herein in its entirety by reference.

1. Field of the Disclosure

The disclosure relates to a beam scanning optical system, and more particularly, to a beam scanning optical system capable of improving resolution.

2. Description of the Related Art

With rapid progress toward a multimedia society, there is demand for large-screen, high-resolution displays. In addition to the higher resolution, more natural color is also recently considered important.

To realize perfect natural color, it is essential to use a light source that has high color purity, such as a laser. Laser beam scanning systems including a scanner reproduce an image using a laser as a light source. Particularly, laser beam scanning systems including a rotating polygonal mirror and a galvanometer mirror have been primarily used. However, such laser beam scanning systems using a rotating polygonal mirror and a galvanometer mirror are expensive and difficult to make compact.

Considering these problems, the present applicant has suggested a laser beam scanning system adopting a micro-electro-mechanical system (MEMS) scanner, in U.S. Pat. No. 6,636,339.

The laser beam scanning system adopting the MEMS scanner is a promising display device for a small form factor, low power consumption, and natural color realization.

To realize a large-screen, high-resolution laser beam scanning system using a MEMS scanner, the scan speed, the scan angle, and the mirror size should be sufficiently large.

Since a laser light is coherent light, there is more diffraction as the width of the laser beam decreases. Accordingly, the width of the laser beam cannot be reduced infinitely. Also, as is well known, a light beam cannot be focused as a point due to its diffractive nature and thereby a limit of resolution exists. In addition, the larger a beam incident on a lens system, the smaller is a beam focused by the lens system.

Accordingly, to enhance resolution, a light beam having proper a width is necessary, and to realize image of high resolution, a large scanning frequency and a large θD value are necessary.

Here, the performance of a raster scanning system is defined in terms of θD [deg·mm]. It is known that the value θD is required to be approximately 7.50 for VGA resolution and approximately 12.00 for XGA resolution. For a high definition display, the product of θ and D is required to be approximately 22.5.

In a laser beam scanning system, θ is a mechanical scan angle of a scanner in one direction in units of degrees, and D is a beam width, that is, the effective mirror size of the scanner in units of millimeters (mm).

To realize a high-resolution scanning system, the mirror size of an MEMS scanner should be large. Also, to realize a large-screen, high-resolution laser beam scanning system, the scan speed should be high.

However, if the mirror size is larger, it is difficult to increase the maximum driving speed of the MEMS scanner due to a physical property such as the moment of inertia, and thereby the scan speed decreases. Accordingly, it is difficult to increase both the scan speed and the mirror size.

Further, the scan angle of the MEMS scanner is limited because it cannot be infinitely increased.

As described above, to realize a large-screen, high-resolution scanning system, the mirror size, the scan speed, and the scan angle should be increased but they are in trade-off relationships with one another. Accordingly, the scanning system employing the MEMS scanner has some restrictions on obtaining a large value OD to achieve high resolution.

So far, a MEMS scanner that has a large-enough mirror size, scan speed, and scan angle to realize a high-definition, large-screen, high-resolution display, has not yet been developed.

### SUMMARY OF THE DISCLOSURE

The present invention may provide a beam scanning optical system, which can improve resolution without increasing the size of a scanning surface.

According to an aspect of the present invention, there may be provided a beam scanning optical system comprising: a scanner scanning an incident light beam; a projection optical system projecting the image of the light beam scanned by the scanner onto an image plane; and a resolution enhancement unit enhancing resolution so that the image of the light beam can be formed on the image plane at a higher resolution than determined by the scanner and the projection optical system.

The resolution enhancement unit may comprise at least one beam expander including at least one lens that expands the light beam scanned by the scanner and sends the light beam onto the projection optical system.

The light beam scanned by the scanner and then incident on the resolution enhancement unit may be a parallel light beam.

The resolution enhancement unit may comprise at least one lens reducing a waste of the light beam passing through the scanner and then proceeding onward.

The light beam incident on the resolution enhancement unit may be a non-parallel light beam focused on a first focal plane in front of the resolution enhancement unit, and the lens may focus the incident light beam on a second focal plane with beam waste less than on the first focal plane.

The resolution enhancement unit may be formed to move corresponding to a beam direction change due to the scanner.

The scanner may be one of a rotating polygonal mirror, a micro-electro-mechanical system (MEMS) scanner, and a galvanometer mirror scanner.

The scanner may include a plurality of scanning surfaces that scan an incident light beam in a single direction, and the resolution enhancement unit comprises: a rotatable holder wheel; and a plurality of optical elements periodically arranged on the holder wheel at the scan angle intervals by the scanner to improve resolution, the optical elements mounted on the holder wheel moving in correspondence with a beam direction change due to the scanner.

The axis of rotation of the holder wheel may coincide with the axis of rotation of the scanner, and the number of the optical elements mounted on the holder wheel may be equal to the number of the scanning surfaces.

The axis of rotation of the holder wheel may be different than the axis of rotation of the scanner.

The axis of rotation of the holder wheel may be spaced apart from the axis of rotation of the scanner in a direction opposite to a direction in which the scanned light beam propagates, and the number of the optical elements mounted on the holder wheel may be greater than the number of the scanning surfaces.

The scanner may include a rotating polygonal mirror.

The scanner may scan an incident light beam in both directions, and the resolution enhancement unit may comprise: two holder wheels rotating in opposite directions; a plurality of first optical elements periodically arranged on one holder wheel at twice the scan angle intervals by the scanner; and a plurality of second optical elements periodically arranged on the other holder wheel at twice the scan angle intervals by the scanner to alternate with the first optical elements, the first and second optical elements mounted on the two holder wheels moving in correspondence with a beam direction change due to the scanner by rotating the two holder wheels in opposite directions corresponding to the rotation of the scanner.

The axis of rotation of the two holder wheels may coincide with the pivoting axis of the scanner.

The axis of rotation of the two holder wheels may be different than the pivoting axis of the scanner.

The axis of rotation of the two holder wheels of the resolution enhancement unit may be spaced apart from the pivoting axis of the scanner in a direction opposite to a direction in which the scanned light beam propagates, and thus the two holder wheels may rotate slower than the scanner.

The scanner may be one of an MEMS scanner and a galvanometer mirror scanner.

According to another aspect of the present invention, there may be provided an optical scanning unit comprising the beam scanning optical system and an f-θ lens acting as the projection optical system.

According to still another aspect of the present invention, there may be provided a projection system comprising the beam scanning optical system to form a projection image.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating the definition of resolvable minimum dimensional pixels;

FIG. 2 is a diagram illustrating a concept for improving resolution according to the present invention;

FIGS. 3A and 3B are respectively a top plan view and a side view illustrating essential parts of a beam scanning optical system according to an embodiment of the present invention;

FIGS. 4 and 5 are diagrams of beam expanders that can be used as a resolution enhancement unit of FIGS. 3A and 3B;

FIG. 6 is a diagram illustrating an optical path through which a light beam scanned by a scanner is focused on an image plane by a projection optical system when there is no beam expander;

FIG. 7 is a diagram illustrating an optical path through which a light beam scanned by the scanner and expanded by a beam expander in front of the projection optical system is focused on the image plane by the projection optical system;

FIGS. 8A and 8B are respectively a top plan view and a side view illustrating essential parts of a beam scanning optical system according to another embodiment of the present invention;

FIG. 9 is a diagram illustrating beam waste on a first focal plane P1 when the system does not include a resolution enhancement unit;

FIG. 10 is a diagram illustrating beam waste when the system includes a resolution enhancement unit, in which beam waste on a second focal plane P2, which is a focal point of a lens constituting the resolution enhancement unit, is less than beam waste on the first focal plane P1;

FIG. 11 is detailed a diagram of an embodiment of the resolution enhancement unit when a rotating polygonal mirror, which scans an incident light beam in a single direction, is used as the scanner of the beam scanning optical system of FIG. 3 or 8;

FIG. 12 is a side view of the resolution enhancement unit of FIG. 11;

FIG. 13 is a graph illustrating relationship between the scanning position of light beam scanned and the positions of optical elements by the scanner and the resolution enhancement unit of FIGS. 11 and 12;

FIG. 14 is a detailed diagram of an embodiment of the resolution enhancement unit when a scanner, which scans an incident light beam in both directions, is used as the scanner of the beam scanning optical system of FIG. 8;

FIG. 15 is a side view of the resolution enhancement unit of FIG. 14; and

FIG. 16 is a graph illustrating the relationship between the scanning position of light beam scanned and the positions of inner and outer lenses by the scanner and the resolution enhancement unit of FIGS. 14 and 16.

### DETAILED DESCRIPTION OF EXEMPLARY EMBODIMENTS

The present invention will now be described more fully with reference to the accompanying drawings, in which preferred exemplary embodiments of the invention are shown.

When the diameter of the mirror surface of a scanner is D and the incidence angle of a light beam incident on the mirror surface of the scanner is δ, the effective diameter Dₘᵢₙ of the scanner is given by Dₘᵢₙ=D cos δ. When the limit of the resolvable angle of a light beam scanned by the scanner is θₘᵢₙ, the limit of the resolvable angle θₘᵢₙ is given by θₘᵢₙ=1.22λ/Dₘᵢₙ for a circular light beam and θₘᵢₙ=λ/Dₘᵢₙ for a square light beam.

When the maximum tilt angle of the mirror surface of the scanner is ±θₘₐₓ, the maximum theoretical number N of resolvable pixels for the circular light beam is given by Equation 1:

$$\begin{matrix}N = 2 {θ}_{max} / {θ}_{min} \\ = 2 {θ}_{max} / ( 1.22 λ / {D}_{min} )\end{matrix} \\ ∝ {θ}_{max} {D}_{min} \qquad ( 1 )$$

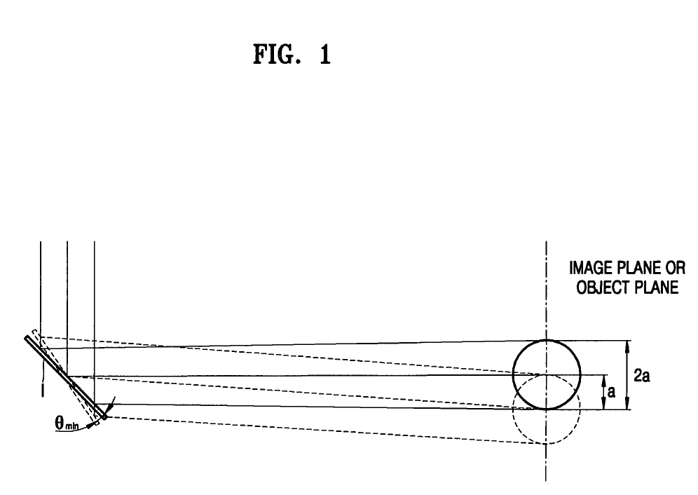

FIG. 1 is a diagram illustrating the definition of resolvable minimum dimensional pixels.

Referring to FIG. 1, when the radius of a light beam spot reflected by a scanner 1 and illuminated to an image plane or an object plane is “a”, the limit θₘᵢₙ of the resolvable angle of a light beam scanned by the scanner 1 is an angle formed when centers of spots are spaced apart from each other by the interval “a”. The size of resolvable minimum dimensional pixels corresponds to the radius of the light beam spot illuminated onto the image plane or the object plane. Here, the image plane may be the screen of a projection system, or the image forming surface of an image forming apparatus using an optical scanning device (e.g., the photosensitive medium surface of a printer). The object plane may be the position which an imaginer such as a liquid crystal display (LCD) in the projection system is located.

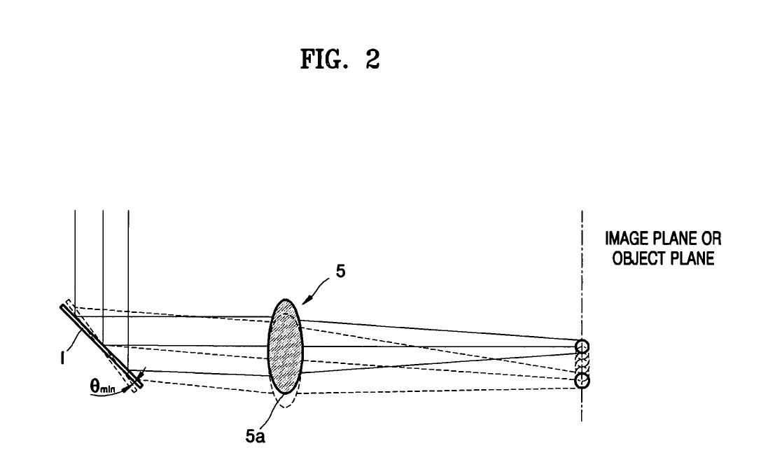

FIG. 2 is a diagram illustrating a concept for improving resolution according to the present invention.

Referring to FIG. 2, a moving optical system 5 is disposed between the scanner 1 and the image plane or the object plane to improve resolution. Accordingly, a light beam spot can be formed on the image plane or the object plane at a resolution higher than the resolution limit determined by the scanner 1.

The moving optical system 5 includes at least one lens 5a. The lens 5a moves corresponding to the pivoting or rotation of the scanner 1 so that the optical axis of the light beam scanned by the scanner 1 can coincide exactly with the central axis of the lens 5a.

As compared with FIG. 1, since the moving optical system 5 for enhancing resolution is interposed between the scanner 1 and the image plane or the object plane in FIG. 2, several resolvable light beam spots can be formed on the image plane or the object plane while the scanner 1 pivots or rotates by the angle θₘᵢₙ, thereby making it possible to resolve more minimum dimensional pixels in comparison with FIG. 1. That is, if the moving optical system 5 is provided as sown in FIG. 2, the size of minimum dimensional pixels can be reduced more than in FIG. 1. Accordingly, the resolution of the beam scanning optical system can be improved based on this principle of the present invention.

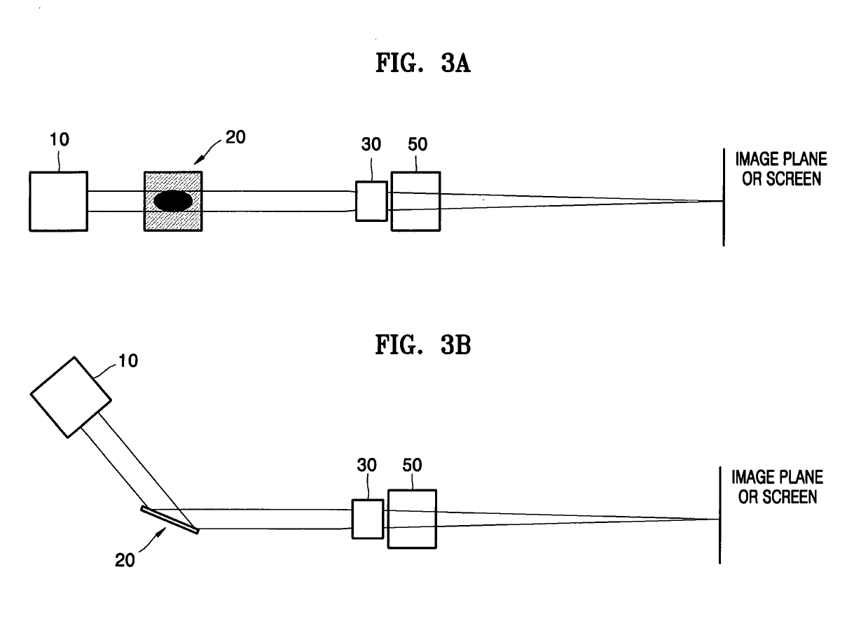

FIGS. 3A and 3B are respectively a top plan view and a side view illustrating essential parts of a beam scanning optical system according to an embodiment of the present invention.

Referring to FIGS. 3A and 3B, the beam scanning optical system according to the present invention includes a scanner 20 scanning a light beam incident from an illumination optical system 10, a projection optical system 50 projecting the image of the light beam scanned by the scanner 20 onto an image plane or a screen, and a resolution enhancement unit 30 for improving resolution. The beam scanning optical system has an optical configuration such that the light beam scanned by the scanner 20 and then incident on the resolution enhancement unit 30 can be a parallel light beam.

The scanner 20 may be a scanner capable of scanning an incident light beam in a single direction, for example, a rotating polygonal mirror having a plurality of scanning mirror surfaces.

The projection optical system 50 may be a projection optical system such as an f-θ lens. When the f-θ lens is used as the projection optical system 50, the beam scanning optical system according to the present embodiment may be used as a laser scanning unit (LSU) for an image forming apparatus, such as a printer or a copier. Here, since the f-θ lens is well known in the field of the LSU, a detailed explanation thereof will not be given.

If the beam scanning optical system of the present embodiment is applied to the image forming apparatus, the image plane may be an image forming surface of a photosensitive medium such as a photosensitive drum.

The resolution enhancement unit 30 enables the image of a light beam to be formed on the image plane at a higher resolution than determined by the scanner 20 and the projection optical system 50.

In the present embodiment, the resolution enhancement unit 30 may include a beam expander having at least one lens that expands the light beam scanned by the scanner 20 and sends the light beam onto the projection optical system 50.

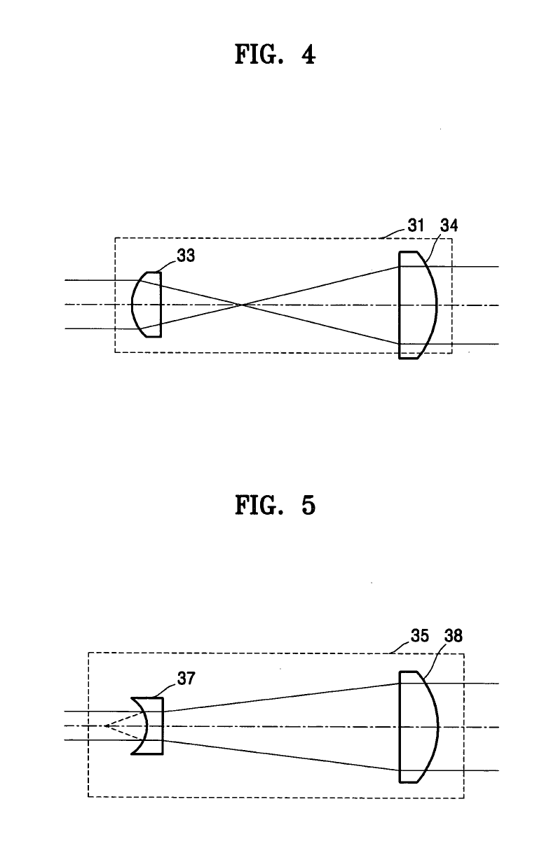

FIGS. 4 and 5 are diagrams of an embodiment of beam expanders 31 and 35 that can be used as the resolution enhancement unit 30 of FIGS. 3A and 3B.

Referring to FIG. 4, the beam expander 31 may include a first lens 33 focusing an incident parallel light beam on a predetermined focal point, and a second lens 34 condensing diverging a light beam passing through the focal point so as to be parallel light. Here, the first and second lenses 33 and 34 are configured so that the light beam emitted from the second lens 34 can be larger than the light beam incident on the first lens 33 and thus the light beam is magnified. FIG. 4 illustrates an example where the first and second lenses 33 and 34 are plane-convex lenses.

Referring to FIG. 5, the beam expander 35 may include a first lens 37 transforming an incident parallel light beam into a diverging light beam, and a second lens 38 transforming the diverging light beam into a parallel light beam. Here, the light beam emitted from the second lens is magnified when compared to the light beam incident on the first lens 37. FIG. 5 illustrates an example where the first lens 37 is a plane-concave lens and the second lens 38 is a plane-convex lens.

Since the beam expanders 31 and 35 used as the resolution enhancement unit 3 can expand the light beam incident on the projection optical system 50, resolution can be improved as follows.

A light beam is not perfectly focused on a point due to its diffractive nature, and thus there exists a resolution limit. As the size of the light beam incident on the lens system increases, the size of the focused light beam decreases.

However, as the mirror size of the scanner increases, it becomes difficult to increase a driving speed due to the physical properties such as the moment of inertia, etc. Accordingly, it is difficult to increase simultaneously both the scan speed and the mirror size. In consideration of these facts, the size of the scanning surface, that is, the mirror surface, of the scanner 20 is appropriately determined.

In short, due to the physical size limit of the scanning surface of the scanner 20 in view of the driving speed and so on, the size of the focused light beam cannot be reduced as much as desired.

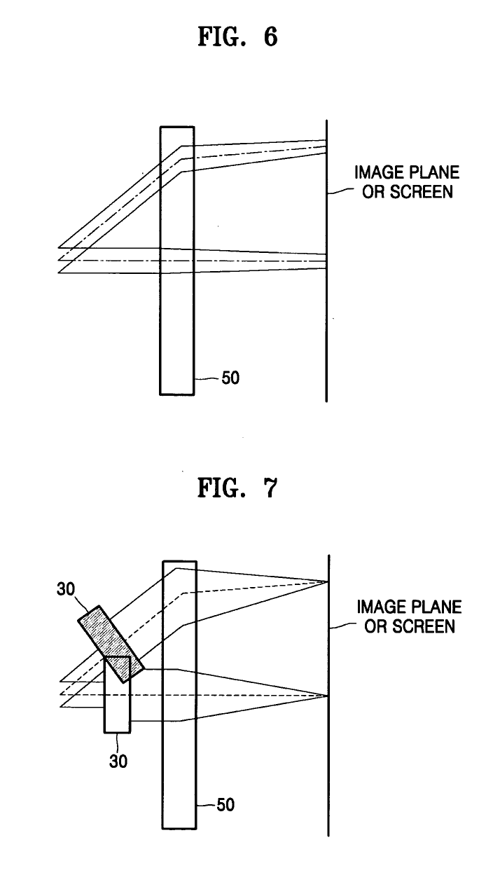

However, since the beam expander 30 used as the resolution enhancement unit 30 can expand the light beam incident on the projection optical system 50, a smaller light beam can be focused than in a case where no expander is used, as is understood from a comparison between FIGS. 6 and 7. Consequently, the size of minimum dimensional pixels can be reduced, and thus resolution can be enhanced.

FIG. 6 is a diagram illustrating an optical path through which the light beam scanned by the scanner 20 is focused on the image plane by the projection optical system 50 when there is no beam expander. FIG. 7 is a diagram illustrating an optical path through which the light beam scanned by the scanner 20 and expanded by the beam expander 30 in front of the projection optical system 50 is focused on the image plane by the projection optical system 50. Here, the beam expander 30 pivots or rotates corresponding to the driving of the scanner 10 so that the optical axis of the light beam scanned by the scanner 10 and the central axis of the beam expander 30 can coincide exactly.

The beam scanning optical system according to the present embodiment may be used as the LSU for the image forming apparatus, such as a printer or a copier, and also can be applied to various other optical systems.

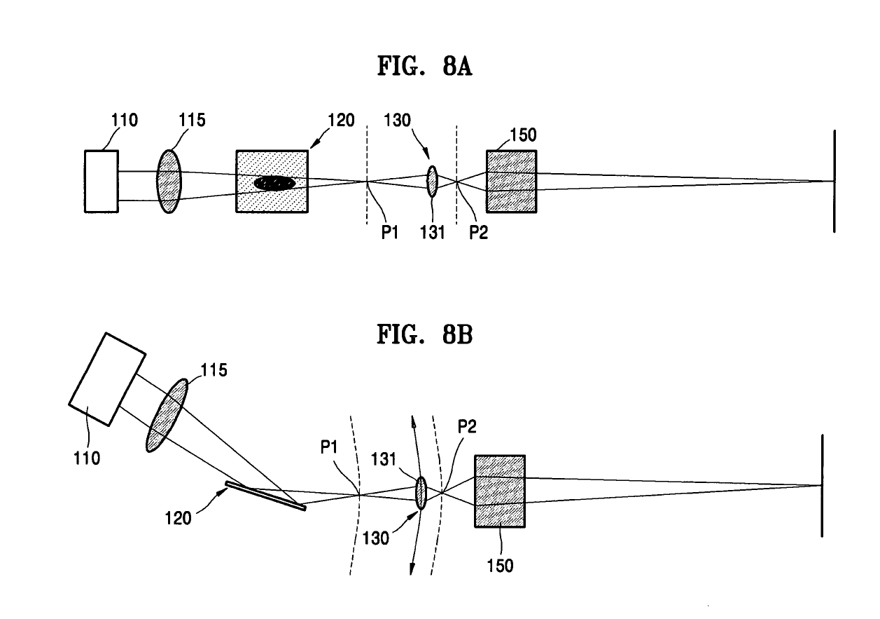

FIGS. 8A and 8B are respectively a top plan view and a side view illustrating essential parts of a beam scanning optical system according to another embodiment of the present invention.

Referring to FIGS. 8A and 8B, the beam scanning optical system of the present embodiment includes a scanner 120 scanning a light beam incident from an illumination optical system 110, a projection optical system 150 projecting the image of the light beam scanned by the scanner 120 onto an image plane or a screen, and a resolution enhancement unit 130 for improving resolution. The beam scanning optical system of the present embodiment is configured so that the light beam scanned by the scanner 120 and then incident on the resolution enhancement unit 130 is a non-parallel light beam.

In the present embodiment illustrated in FIG. 8, it is preferable that the scanner 120 is able to scan the incident light beam in both directions. Alternatively, a scanner that is only capable of scanning the incident light beam in a single direction may be used as the scanner 120. The bi-directional scanner includes a micro-electro-mechanical system (MEMS) scanner and a galvanometer mirror scanner. The mono-directional scanner includes a rotating polygonal mirror having a plurality of scanning mirror surfaces.

The projection optical system 150 may be an image relay optical system such as a projection lens unit. Further, the projection optical system 150 may be an f-θ lens.

When the beam scanning optical system of the present embodiment illustrated in FIG. 8 includes image relay optical systems as the projection optical system 150, the beam scanning optical system can be applied to a projection system for forming a one- or two-dimensional projection image, for example, a projection display such as a projector or a projection television or a head-mounted display that forms an image on a user's retina. Here, since the projection lens unit is well known in the field of projection apparatus, a detailed explanation thereof will not be given.

Also, when the beam scanning optical system of the present embodiment illustrated in FIG. 8 uses the f-θ lens as the projection optical system 150, the beam scanning optical system can be used as an LSU of an image forming apparatus, such as a printer. Here, the LSU scans an image in both directions.

The beam scanning optical system of the present embodiment illustrated in FIG. 8 has an optical configuration so that the light beam incident on the scanner 120 can be a non-parallel beam focused on a first focal plane P1 in front of the resolution enhancement unit 130. FIGS. 8A and 8B illustrate an example where a condensing lens 115 focuses the light beam emitted from the illumination optical system 110 on the first focal plane P1. The condensing lens 115 may be composed of one or a plurality of lenses, and may reside in the illumination optical system 110.

The resolution enhancement unit 130 includes at least one lens 131 for reducing a waste of the light beam passing through the scanner 120 and proceeding onward. Although FIGS. 8A and 8B show an example in which the resolution enhancement unit 130 is composed of one lens 131, the resolution enhancement unit 130 may be composed of a plurality of lenses.

The lens 131 focuses the incident light beam diverging from the first focal plane P1 on a second focal plane P2 with beam waste less than on the first focal plane P1.

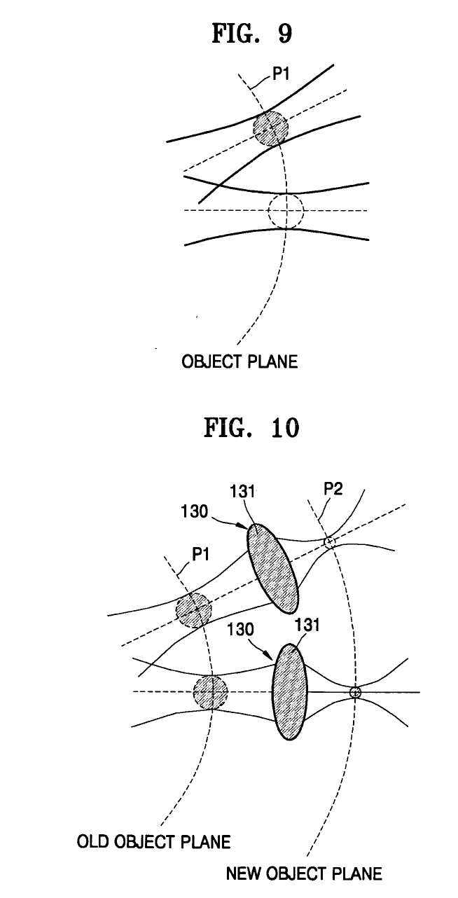

Here, as shown in a comparison between FIGS. 9 and 10, when the beam scanning optical system employs the resolution enhancement unit 130, the beam waste on the second focal plane P2 can be less than the beam waste on the focal plane P1. Accordingly, the minimum dimensional pixel size can be reduced, and thus resolution can be improved.

FIG. 9 is a diagram illustrating beam waste on the first focal plane P1 when the system does not include the resolution enhancement unit 130. FIG. 10 is a diagram illustrating beam waste on the second focal plane P2, which is a focal point of the lens 131 constituting the resolution enhancement unit 130, being less than beam waste on the first focal plane P1, when the system includes the resolution enhancement unit 130.

In FIG. 9, the first focal plane P1 becomes an object plane. In FIG. 10, the second focal plane P2 becomes an object plane. That is, the first focal plane P1 corresponds to an old object plane when the system does not employ the resolution enhancement unit 130, and the second focal plane P2 corresponds to a new object plane when the resolution enhancement unit 130 is disposed between the first focal plane P1 and the projection optical system 150.

Here, the lens 131 of the resolution enhancement unit 130 pivots or rotates corresponding to the driving of the scanner 120 so that the optical axis of the light beam scanned by the scanner 120 can coincide exactly with the central axis of the lens 131.

In the meanwhile, when the resolution enhancement unit 130 is used as shown in the present embodiment, the second focal plane P2 corresponds to an object plane positioned of an LCD imager in an LCD projector. A virtual image formed on the second focal plane P2 is projected onto a screen by the image relay optical system acting as the projection optical system 150. The screen is a general screen that shows the image projected by the projection optical system. Further, when the projection system is a head-mounted display, the screen corresponds to the user's retina.

Here, if the beam scanning optical system does not employ the resolution enhancement unit 130, the first focal plane P1 becomes an object plane, and the first focal plane P1 becomes the surface of the LCD imager in the LCD projector.

Since the beam scanning optical system according to the present embodiment illustrated in FIG. 8 can reduce the waste of the light beam focused on the object plane by means of the resolution enhancement unit 130, the minimum dimensional pixel size can be reduced and resolution can be enhanced.

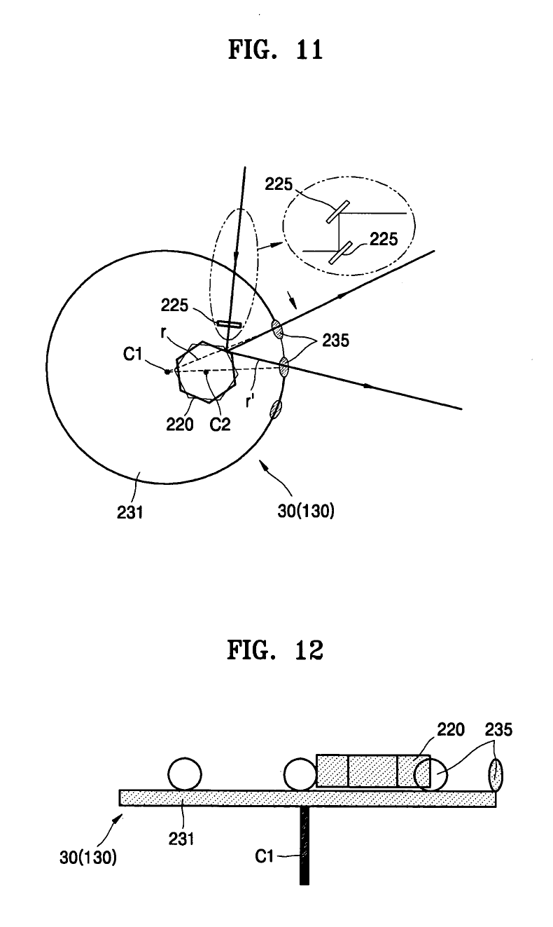

FIG. 11 is a detailed diagram of an embodiment of the resolution enhancement unit 30 or 130 when a rotating polygonal mirror 220, which scans an incident light beam in a single direction, is used as the scanner 20 or 120 of the beam scanning optical system of FIG. 3 or 8. FIG. 12 is a side view of the resolution enhancement unit 30 or 130 of FIG. 11.

Referring to FIGS. 11 and 12, the resolution enhancement unit 30 or 130 includes a rotatable holder wheel 231, and a plurality of optical elements 235 arranged on the holder wheel 231 at the scan angle intervals of the rotating polygonal mirror 220 to improve resolution. Here, the optical element 235 may be the beam expander 31 or 35 described with reference to FIGS. 4 through 7, or the at least one lens 131 for reducing the beam waste on the object plane described with reference to FIGS. 8A through 10.

A portion marked by a dash-dot-dot line in FIG. 11 shows mirrors 225 for adjusting the height of the light beam incident on the scanning mirror surface of the rotating polygonal mirror 220. The mirrors 225 may be omitted. Although FIG. 11 shows some lenses 131, the lenses 131 are arranged at regular intervals around the entire circumference of the holder wheel 231.

The holder wheel 231 is rotated by a driving source (not shown) to move the optical elements 235 mounted thereon corresponding to a scanned beam direction change due to the rotation of the rotating polygonal mirror 220.

Here, the axis of rotation C1 of the holder wheel 231 may be different from the axis of rotation C2 of the rotating polygonal mirror 220.

FIG. 11 shows the axis of rotation C1 of the holder wheel 231 being spaced apart from the axis of rotation C2 of the rotating polygonal mirror 220 in a direction opposite to the propagation of the light beam scanned by the rotating polygonal mirror 220. In this case, the number of the optical elements 235 mounted on the holder wheel 231 is greater than the number of the scanning surfaces of the rotating polygonal mirror 220, that is, the number of scanning mirror surfaces, and the holder wheel 231 rotates more slowly than the rotating polygonal mirror 220.

Here, when the rotation speed (angular frequency) of the rotating polygonal mirror 220 is f, a scan time is 1/(f×number of scanning surfaces) and a maximum scan angle θ1 is given by θ1=(360°/number of scanning surfaces)×2.

When a linear distance between the position of the light beam incident on the scanning surface and the optical element 235 is r′, an optical element movement distance during scanning by one scanning surface is θ1×r′.

When a distance between the axis of rotation C1 of the holder wheel 231 and the optical elements 235, that is, the effective radius of the holder wheel 231, is r, the angle θ2 between a line connecting the axis of rotation C1 and one optical element 235 and another line connecting the axis of rotation C1 and neighboring optical element 235 is given by θ2=θ1×r′/r, and the number m of the optical elements 235 disposed around the circumference of the holder wheel 231 is obtained from 360°=m×θ2 where m is an integer.

Accordingly, the size r of the holder wheel 231 becomes r=(2×m/number of scanning surfaces)×r′, from θ2=θ1×r′/r and 360°=m×θ2 where m is an integer and r>r′.

The rotation speed of the holder wheel 231 is 1/(scan time×m)=f×(number of scanning surfaces/m).

The optical elements 235 are arranged on the holder wheel 231 at angular intervals of θ2.

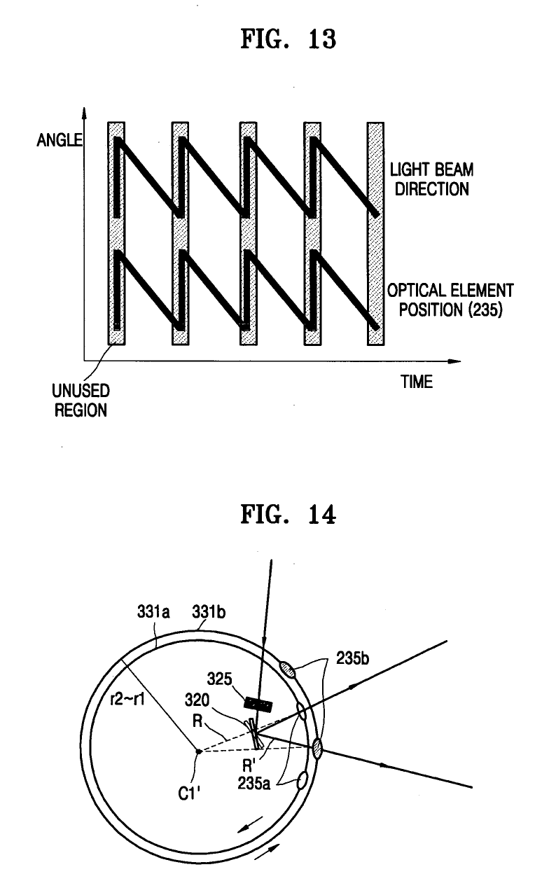

FIG. 13 is a graph illustrating relationship between the scanning position of the light beam scanned and the position of the optical element by the scanner 20 or 120 and the resolution enhancement unit 30 or 130 shown in FIGS. 11 and 12. In FIG. 13, the horizontal axis represents time, the vertical axis represents angle, and marked regions are unused regions corresponding to edges of the rotating polygonal mirror 220.

Meanwhile, even in the mono-directional scanning structure, the resolution enhancement unit 30 or 130 may be arranged so that the axis of rotation C1 of the holder wheel 231 thereof can coincide exactly with the axis of rotation C2 of the rotating polygonal mirror 220.

In this case, the number of the optical elements 235 mounted on the holder wheel 231 is equal to the number of the scanning surfaces of the rotating polygonal mirror 220, and the holder wheel 231 rotates at the same speed as the rotating polygonal mirror 220.

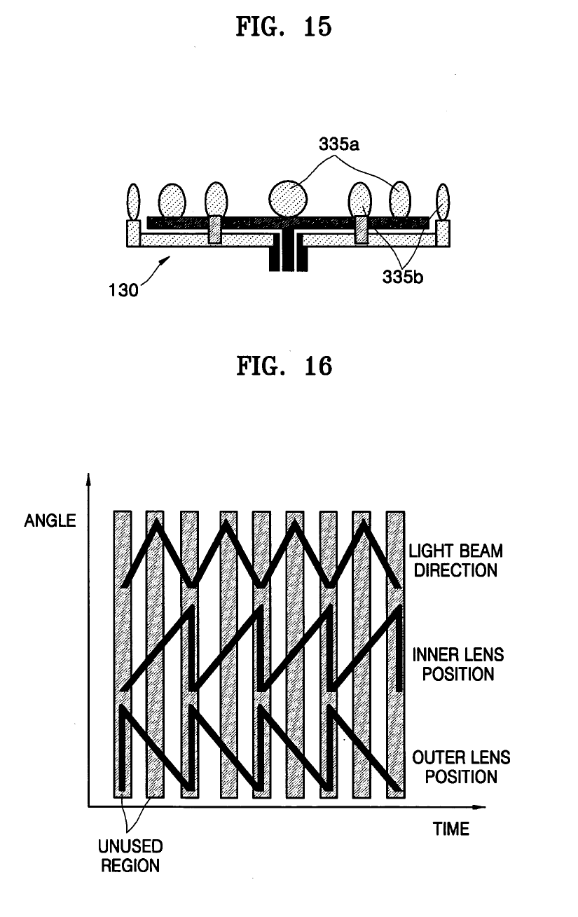

FIG. 14 is a detailed diagram of an embodiment of the resolution enhancement unit 130 when a scanner 320, which scans an incident light beam in both directions, is used as the scanner 120 of the beam scanning optical system of FIG. 8. FIG. 15 is a side view of FIG. 14.

Referring to FIGS. 14 and 15, the resolution enhancement unit 130 includes first and second holder wheels 331a and 331b rotating in opposite directions, a plurality of first optical elements 335a periodically arranged on the first holder wheel 331a at twice the scan angle intervals of the scanner 320 to improve resolution, and a plurality of second optical elements 335b periodically arranged on the second holder wheel 331b at twice the scan angle intervals of the scanner 320 to improve resolution to be positioned in the intervals of neighboring two first optical elements 335a. Here, the bi-directional scanner 320 may be an MEMS scanner or a galvanometer mirror scanner.

The first and second optical elements 335a and 335b may be the lenses 131 for reducing beam waste on the object plane previously described with reference to FIGS. 8A through 10. Although FIG. 14 shows some of the first and second optical elements 335a and 335b, the first and second optical elements 335a and 335b are respectively arranged at regular intervals around the entire circumference of the first and second holder wheels 331a and 331b.

Reference numeral 325 in FIG. 14 denotes mirrors for adjusting the height of the light beam incident on the scanner 320, like the mirrors 225 in FIG. 11. The mirrors 325 may be omitted.

The first and second holder wheels 331a and 331b are rotated in opposite directions by a driving source (not shown) to move the first and second optical elements 335a and 335b mounted thereon corresponding to a light beam direction change due to the driving of the scanner 320.

It is preferable that the first and second holder wheels 331a and 331b be disposed on the same axis. It is preferable that a distance between the first and second optical elements 335a and 335b be minimized in a radial direction. That is, it is preferable that the positions of the first and second optical elements 335a and 335b in the radial direction with respect to the axis of rotation C1′ of the first and second holder wheels 331a and 331b be almost the same and the effective radii of the first and second holder wheels 331a and 331b be almost the same. Referring to FIG. 14, the first and second holder wheels 331a and 331b are formed so that the first optical elements 335a are closer to the axis of rotation C1′ than the second optical elements 335b are, and the first and second optical elements 335a and 335b are mounted on the first and second holder wheels 331a and 331b. Here, the first optical elements 335a are inner lenses, and the second optical elements 335b are outer lenses.

Meanwhile, the axis of rotation C1′ of the first and second holder wheels 331a and 331b may be different from the pivoting axis of the scanner 320.

FIG. 14 shows an example where the axis of rotation C1′ of the first and second holder wheels 331a and 331b is spaced apart from the pivoting axis of the scanner 320 in a direction opposite to a direction in which the light beam scanned by the scanner 320 propagates. In this case, the first and second holder wheels 331a and 331b rotate slower than the pivoting speed of the scanner 320.

Here, when the pivoting speed of the scanner 320 is f, a scan time t1 in one direction is t1=1/f, and the optical scan angle θ1′ by the scanner 320 is four times the mechanical scan angle (the maximum scan angle in one direction) of the scanner 320.

When a scan angle with respect to the axis of rotation C1′ of the first and second holder wheels 331a and 331b, corresponding to the optical scan angle θ1′, is θ2′, the first and second optical elements 335a and 335b are periodically arranged on the first and second holder wheels 331a and 331b at angular intervals of 2×θ2′. The scan angle θ2′ corresponds to an angle between a line connecting the axis of rotation C1′ and the first optical elements 335a and another line connecting the axis of rotation C1′ and the second optical elements 335b.

It is assumed that a substantial linear distance between the position of light beam incident on the scanning surface of the scanner 320 and the first and second optical elements 335a and 335b is R′ and a distance from the axis of rotation C1′ of the first and second holder wheels 331a and 331b to the first and second optical elements 335a and 335b, that is, the effective radius of the first and second holder wheels 331a and 331b is R. Here, the effective radius r1 of the first holder wheel 331a is almost equal to the effective radius r2 of the second holder wheel 331 b (r2≈r1).

In this case, the angle θ2′ between the line connecting the axis of rotation C1″ of the first and second holder wheels 331a and 331b and the first optical elements 335a and another line connecting the axis of rotation C1′ and the second optical elements 335b is given by θ2′=θ1′×R′/R. The number M of the first and second optical elements 335a and 335b disposed around the circumference of the first and second holder wheels 331a and 331b is obtained from 360°=2×M×θ2′ where M is a positive integer.

From equations θ2′=θ1′×R′/R and 360°=2×M×θ2′, the substantial effective radius R of the first and second holder wheels 331a and 331b is given by R=θ1′×2×M/360°×R′. An angle 2θ2′ between the first or second optical elements 335a or 335b is given by 2θ2′=2×θ1′×R′/R. The rotation speed of the first and second holder wheels 331a and 331b is 1/(t1×M)=f/M.

FIG. 16 is a graph illustrating relationship between the scanning position of light beam scanned and the positions of the first and second optical elements 335a and 335b, that is, the positions of the inner and outer lens positions by the scanner 320 and the resolution enhancement unit 130 shown in FIGS. 14 and 15. In FIG. 16, the horizontal axis represents time, the vertical axis represents angle, and marked regions are unused regions where the first and second optical elements 335a and 335b overlap.

Referring to FIG. 16, a light beam is scanned in both directions, and the first and second optical elements 335a and 335b, that is, the inner and outer lenses, are respectively arranged at intervals of time during which the scanner 320 pivots in one direction and pivots in the opposite direction to be returned to its original position. The first and second optical elements 335a and 335b move in opposite directions to each other.

On the other hand, even in the bi-directional scanning structure, the resolution enhancement unit 130 can be arranged so that the axis of rotation C1′ of the first and second holder wheels 331a and 331b can coincide with the axis of rotation of the scanner 320.

In this case, an arrangement interval between the first or second optical elements 335a and 335b mounted on the first and second holder wheels 331a or 331b is 2θ1′, and the rotation speed of the first and second holder wheels 331a and 331b is f/N. Here, N is an integer given by N=360°/(2×θ1′).

As described above, the beam scanning optical system according to the present invention includes the resolution enhancement unit disposed between the scanner and projection optical system to expand an incident light beam or refocus the light beam, thereby reducing beam waste and improviding resolution without increasing the size of the scanning surfaces.

Accordingly, the present invention can enhance resolution irrespective of the limit on the size of the scanner.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A beam scanning optical system comprising:
a scanner for scanning an incident light beam;
a projection optical system for projecting the image of the light beam scanned by the scanner onto an image plane; and
a resolution enhancement unit for enhancing resolution so that the image of the light beam can be formed on the image plane at a higher resolution than determined by the scanner and the projection optical system.

2. The beam scanning optical system of claim 1, wherein the resolution enhancement unit comprises at least one beam expander including at least one lens that expands the light beam scanned by the scanner and sends the light beam onto the projection optical system.

3. The beam scanning optical system of claim 2, wherein the light beam scanned by the scanner and then incident on the resolution enhancement unit is a parallel light beam.

4. The beam scanning optical system of claim 1, wherein the resolution enhancement unit comprises at least one lens for reducing a waste of the light beam passing through the scanner and then proceeding onward.

5. The beam scanning optical system of claim 4, wherein the light beam incident on the resolution enhancement unit is a non-parallel light beam focused on a first focal plane in front of the resolution enhancement unit, and the lens focuses the incident light beam on a second focal plane with beam waste less than on the first focal plane.

6. The beam scanning optical system of claim 4, wherein the resolution enhancement unit is formed to move corresponding to a beam direction change due to the scanner.

7. The beam scanning optical system of claim 2, wherein the resolution enhancement unit is formed to move corresponding to a beam direction change due to the scanner.

8. The beam scanning optical system of claim 1, wherein the resolution enhancement unit is formed to move corresponding to a beam direction change due to the scanner.

9. The beam scanning optical system of claim 1, wherein the scanner is one of a rotating polygonal mirror, a micro-electro-mechanical system (MEMS) scanner, and a galvanometer mirror scanner.

10. The beam scanning optical system of claim 1, wherein the scanner includes a plurality of scanning surfaces that scan an incident light beam in a single direction, and
the resolution enhancement unit comprises:
a rotatable holder wheel; and
a plurality of optical elements periodically arranged on the holder wheel at the scan angle intervals by the scanner to improve resolution, the optical elements mounted on the holder wheel being movable in correspondence with a beam direction change due to the scanner.

11. The beam scanning optical system of claim 10, wherein the axis of rotation of the holder wheel coincides with the axis of rotation of the scanner, and the number of the optical elements mounted on the holder wheel is equal to the number of the scanning surfaces.

12. The beam scanning optical system of claim 10, wherein the axis of rotation of the holder wheel is different from the axis of rotation of the scanner.

13. The beam scanning optical system of claim 12, wherein the axis of rotation of the holder wheel is spaced apart from the axis of rotation of the scanner in a direction opposite to a direction in which the scanned light beam propagates, and the number of the optical elements mounted on the holder wheel is greater than the number of the scanning surfaces.

14. The beam scanning optical system of claim 10, wherein the scanner includes a rotating polygonal mirror.

15. The beam scanning optical system of claim 1, wherein the scanner scans an incident light beam in both directions, and
the resolution enhancement unit comprises:
two holder wheels capable of rotating in opposite directions;
a plurality of first optical elements periodically arranged on one holder wheel at twice the scan angle intervals by the scanner; and
a plurality of second optical elements periodically arranged on the other holder wheel at twice the scan angle intervals by the scanner to alternate with the first optical elements, the first and second optical elements mounted on the two holder wheels being movable in correspondence with a beam direction change due to the scanner by rotating the two holder wheels in opposite directions corresponding to the rotation of the scanner.

16. The beam scanning optical system of claim 15 wherein the axis of rotation of the two holder wheels coincides with the pivoting axis of the scanner.

17. The beam scanning optical system of claim 15, wherein the axis of rotation of the two holder wheels is different from the pivoting axis of the scanner.

18. The beam scanning optical system of claim 16, wherein the axis of rotation of the two holder wheels of the resolution enhancement unit is spaced apart from the pivoting axis of the scanner in a direction opposite to a direction in which the scanned light beam propagates, and thus the two holder wheels rotate slower than the scanner.

19. The beam scanning optical system of claim 15, wherein the scanner is one of an MEMS scanner and a galvanometer mirror scanner.

20. The beam scanning optical system of claim 10, wherein the optical elements include a beam expander having at least one lens that expands the light beam scanned by the scanner and sends the light beam onto the projection optical system.

21. The beam scanning optical system of claim 20, wherein the light beam scanned by the scanner and then incident on the resolution enhancement unit is a parallel light beam.

22. The beam scanning optical system of claim 10, wherein the optical elements include at least one lens for reducing a waste of the light beam passing through the scanner and proceeding onward.

23. The beam scanning optical system of claim 22, wherein the light beam incident on the resolution enhancement unit is a non-parallel light beam focused on a first focal plane in front of the resolution enhancement unit, and the optical element of the resolution enhancement unit focuses the incident light beam on a second focal plane with beam waste less than on the first focal plane.

24. An optical scanning unit comprising the beam scanning optical system of claim 1 and an f-θ lens acting as the projection optical system.

25. The light scanning device of claim 24, wherein the resolution enhancement unit comprises at least one beam expander including at least one lens that expands the light beam scanned by the scanner and sends the light beam onto the projection optical system.

26. The beam scanning optical system of claim 24, wherein the resolution enhancement unit comprises at least one lens for reducing a waste of the light beam passing through the scanner and proceeding onward.

27. The beam scanning optical system of claim 24, wherein the scanner includes a plurality of scanning surfaces that scan an incident light beam in a single direction, and
the resolution enhancement unit comprises:
a rotatable holder wheel; and
a plurality optical elements periodically arranged on the holder wheel at the scan angle intervals of the scanner to improve resolution, the optical elements mounted on the holder wheel being movable in correspondence with a beam direction change due to the scanner.

28. The beam scanning optical system of claim 27, wherein the scanner includes a rotatable polygonal mirror.

29. The beam scanning optical system of claim 24, wherein the scanner scans an incident light beam in both directions, and
the resolution enhancement unit comprises:
two holder wheels capable of rotating in opposite directions;
a plurality of first optical elements periodically arranged on one holder wheel at twice the scan angle intervals of the scanner; and
a plurality of second optical elements periodically arranged on the other holder wheel at twice the scan angle intervals of the scanner to alternate with the first optical elements, the first and second optical elements mounted on the two holder wheels being movable in correspondence with a beam direction change due to the scanner by rotating the two wheels in opposite directions corresponding to the rotation of the scanner.

30. The beam scanning optical system of claim 29, wherein the scanner is one of an MEMS scanner and a galvanometer mirror scanner.

31. A projection system comprising the beam scanning optical system of claim 1 to form a projection image.

32. The projection system of claim 31, wherein the resolution enhancement unit comprises at least one beam expander including at least one lens that expands the light beam scanned by the scanner and sends the light beam onto the projection optical system.

33. The projection system of claim 31, wherein the resolution enhancement unit comprises at least one lens for reducing a waste of the light beam passing through the scanner and proceeding onward.

34. The projection system of claim 31, wherein the scanner includes a plurality of scanning surfaces that scan an incident light beam in a single direction, and
the resolution enhancement unit comprises:
a rotatable holder wheel; and
a plurality of optical elements periodically arranged on the holder wheel at the scan angle intervals of the scanner to improve resolution, the optical elements mounted on the holder wheel being movable in correspondence with a beam direction change due to the scanner.

35. The projection system of claim 34, wherein the scanner includes a rotating polygonal mirror.

36. The projection system of claim 31, wherein the scanner scans an incident light beam in both directions, and
the resolution enhancement unit comprises:
two holder wheels capable of rotating in opposite directions;
a plurality of first optical elements periodically arranged on one holder wheel at twice the scan angle intervals of the scanner; and
a plurality of second optical elements periodically arranged on the other holder wheel at twice the scan angle intervals of the scanner to alternate with the first optical elements, the first and second optical elements mounted on the two holder wheels being movable in correspondence with a beam direction change due to the scanner by rotating the two holder wheels in opposite directions corresponding to the rotation of the scanner.

37. The projection system of claim 36, wherein the scanner is one of an MEMS scanner and a galvanometer mirror scanner.
